(19) United States
(12) Patent Application Publication
(10) Pub. No.: US 2018/0025084 A1
(43) Pub. Date: Jan. 25, 2018

(54) AUTOMATIC RECOMMENDATIONS FOR CONTENT COLLABORATION

(71) Applicant: MICROSOFT TECHNOLOGY LICENSING, LLC, Redmond, WA (US)

(72) Inventors: Patrick Conlan, Seattle, WA (US); Yi-Lei Wu, Redmond, WA (US); Sandipan Ganguly, Redmond, WA (US); Rui Hu, Redmond, WA (US)

(73) Assignee: MICROSOFT TECHNOLOGY LICENSING, LLC, Redmond, WA (US)

(21) Appl. No.: 15/213,427

(22) Filed: Jul. 19, 2016

(51) Int. Cl. G06F 17/30; G06Q 10/10

(52) U.S. Cl. CPC G06F 17/30867; G06Q 10/101; G06F 17/30011; G06F 17/30876; G06F 17/30554; G06F 17/3053

(57) ABSTRACT

Increasingly, productivity services are executed in collaborative environments. While new collaboration features may provide users with a rich set of tools to expand collaboration methods and gain productivity, users may not be aware of the features' existence. Embodiments are directed to automatic provision of recommendations for content collaboration. Actions performed in conjunction with a document may be monitored to determine a usage pattern associated with the document in response to detecting an opening of the document through an application user experience. An identifier associated with the document and other interactions with the document may be determined. A recommendation may then be provided or display through the application user experience based on the usage pattern associated with the document, the identifier, and the other interactions with the document. The recommendation may include collaboration tool(s) that may be implemented in response to a selection of the recommendation through the application user experience.

### BACKGROUND

Productivity services may enable users to create, edit, share, and present a variety of content. Increasingly, productivity services are being executed in collaborative environments, such that multiple users co-authoring a document or file, for example, may more efficiently edit and share the updated content among one another. With new collaboration features available through the productivity services, users may have a rich set of tools to improve their collaboration methods and gain in their productivity. However, users may not be aware of the existence of these available collaboration features.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to provision of automatic recommendations for content collaboration. In response to detection of an opening of a document through an application user experience, one or more actions performed in conjunction with the document may be monitored to determine a usage pattern associated with the document. An identifier associated with the document may be determined and other interactions with the document may be determined based on the identifier. A recommendation may then be provided for display through the application user experience based on the usage pattern associated with the document, the identifier, and the other interactions with the document, where the recommendation may include one or more collaboration tools.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A-B include example network environments where a system to automatically provide recommendations for content collaboration may be implemented;

FIG. 2 illustrates a conceptual diagram of example levels of document collaboration;

FIG. 3 illustrates a conceptual diagram of an influence score implemented to determine a recommendation for content collaboration to be provided;

FIG. 4 illustrates example scenarios for automatic provision of recommendations for content collaboration;

FIGS. 5A-B illustrate recommendations configured as window notifications;

FIG. 6 illustrates a recommendation configured as a ribbon notification;

FIG. 7 illustrates a recommendation configured as an email notification;

FIG. 8 illustrates an example service and integrated modules of the service configured to automatically provide recommendations for content collaboration;

FIG. 9 is a networked environment, where a system according to embodiments may be implemented;

FIG. 10 is a block diagram of an example general purpose computing device, which may be used to automatically provide. recommendations, for content collaboration; and

FIG. 11 illustrates a logic flow diagram of a method to automatically provide recommendations for content collaboration, according to embodiments.

### DETAILED DESCRIPTION

As briefly described above, a large part of today's productivity involves collaborating with others, and new collaboration features made as through productivity services may provide customers with a rich set of tools to improve their collaboration methods and gain in their productivity. However, customers may not be aware of the existence of these collaboration features. Therefore, embodiments are directed to provision of automatic recommendations for content collaboration. In response to detection of an opening of a document through an application user experience, one or more actions performed in conjunction with the document may be monitored to determine a usage pattern associated with the document. An identifier associated with the document may be determined and other interactions with the document may be determined based on the identifier. A recommendation may then be provided for display through the application user experience based on the usage pattern associated with the document, the identifier, and the other interactions with the document, where the recommendation may include one or more collaboration tools. The collaboration tools may include communication-based tools, file-sharing tools, co-authoring tools, real-time typing tools, and/or networking-based tools, among other similar collaboration tools. The recommendation may be configured and displayed as a notification through a window, a ribbon, and/or through e-mail, for example, where a user may be enabled to select one or more of the collaboration tools for implementation through the notification.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can fix example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide automatic recommendations for content collaboration. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

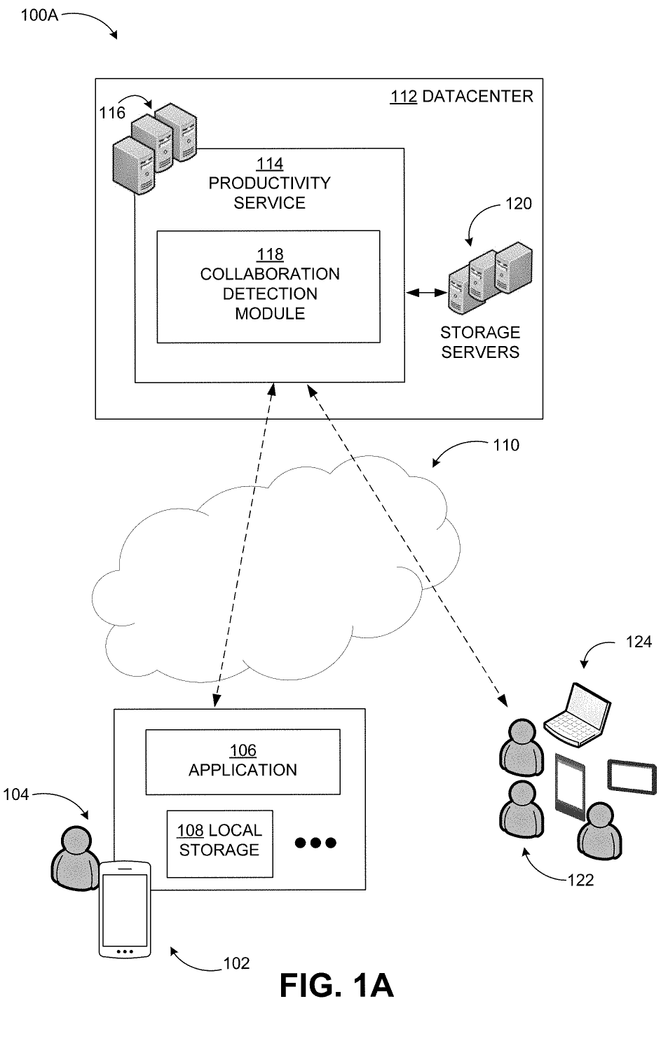

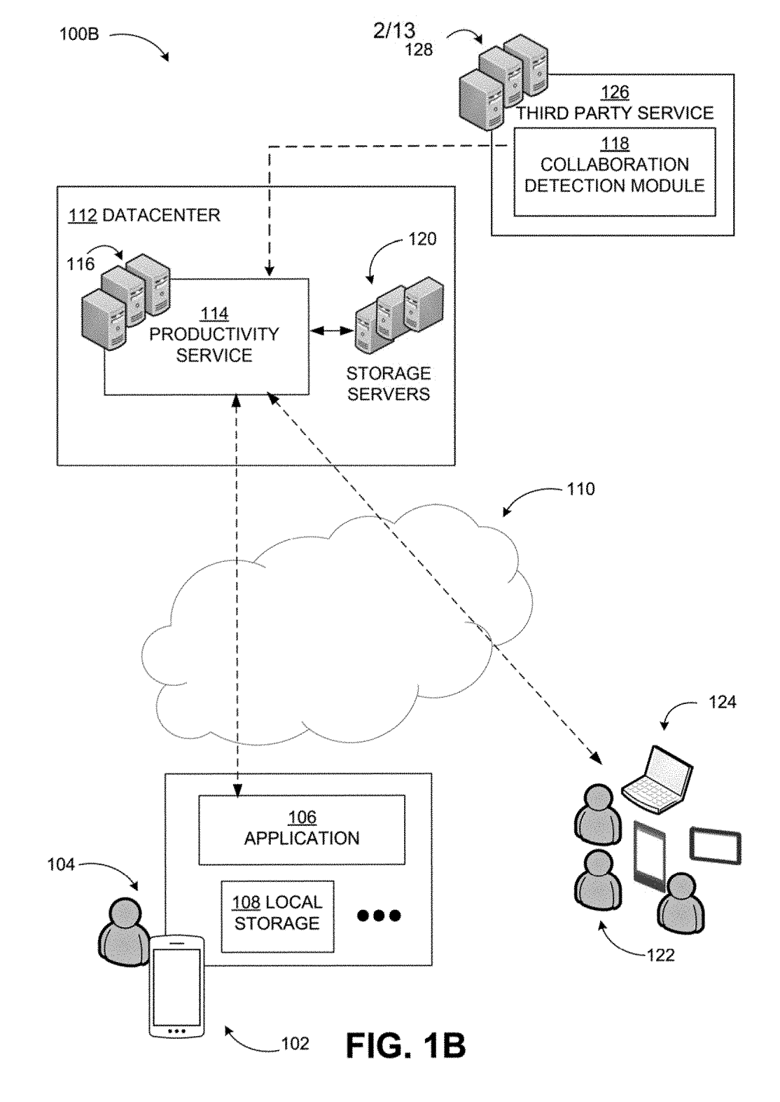

FIGS. 1A-B include example network environments where a system to automatically provide recommendations for content collaboration may be implemented. As illustrated in diagram 100A of FIG. 1A, an example system may include a datacenter 112 hosting a productivity service 114 configured to enable one or more users to create, edit, share and/or present a variety of content. The datacenter 112 may include one or more processing servers 116, of which, at least one may be operable to execute a collaboration detection module 118 of the productivity service 114, among other components. The datacenter 112 may also include one or more storage servers 120 configured to manage one or more data stores comprising data associated with the, productivity service 114 and/or collaboration detection module HS. As described herein, the collaboration detection module 118 may be implemented as software, hardware, or combinations thereof.

As further illustrated in the diagram 100, a customer 104 may execute a thin (e.g., a web browser) or a thick (e.g., a locally installed client application) version of an application 106 through a device 102 with which the productivity service 114 may be configured to integrate and interoperate with over one or more networks, such as network 110. The application 106 may be a productivity application, such as a word-processing application, a spreadsheet application, a presentation application, a communication application, or a notebook application, for example. The device 102 may include a desktop computer, a laptop computer, a tablet computer, a vehicle mount computer, a smart phone, or a wearable computing device, among other similar devices. A communication interface may facilitate communication between the productivity service 114 and the application 106 over the network 110.

Alternatively, as shown in a diagram 100B of FIG. 1B, the productivity service 114 may be configured to interact with a third party service 126 over the network 110 to provide automatic recommendations for content collaboration utilizing the collaboration detection module 118. The third party service 126 may include one or more processing servers 128, of which, at least one may be operable to execute the collaboration detection module 118.

In one embodiment, in response to detection of an opening of a document through a user experience of the application 105, the collaboration detection module 118 may be configured to monitor actions performed in conjunction with the document. For example, the monitored actions may include editing, annotating, commenting, sharing, and/or saving of the document by the customer 104. The collaboration detection module 118 may be configured to determine a usage pattern associated with the document based on the monitored actions, such as a frequency at which the customer 104 interacts with the document, types of actions the customer 104 performs on the document, and a frequency of those specific types of actions, among other examples, in some embodiments, the collaboration detection module 118 may be configured to filter the monitored actions based on a length and/or type of action such that non-relevant and/or “accidental” actions may not be included in the determination of the usage pattern. For example, if the customer 104 opens a document, and then closes the document within ten seconds, the action may be filtered out as it is likely that the customer 104 merely opened the document by mistake.

The collaboration detection module 118 may also be configured to determine an identifier associated with the document. The identifier may include information associated with the creation, editing, and/or sharing of the document among the customer 104 and one or more other customers or use's 122 collaborating on the document. The identifier may include all users who have interacted with the document, a frequency at which the users interacted with the document, and relationships between the users who have interacted with the document. Additionally, the identifier may include any tags associated with the document, a content type of the document, other documents related to the document, and/or any other attributes of the documents, among other examples. In an example scenario, the identifier may indicate that the document is a task of a project related to one or more other documents associated with a same or different task of that project because the users who have interacted with the document belong to a same team, group and/or organization responsible for that project.

The collaboration detection module 118 may further be configured to determine other interactions with the document based on the identifier. For example, usage patterns associated with the document may be determined for the other customers or users 122 who are identified to be collaborating on the document with the customer 104 through various devices 124 associated with the other customers or users 122. The usage patterns may be determined by monitoring actions of the other customers or users 122 in conjunction with the document. Other interactions may also include local semantic analysis of the document, where the local semantic analysis may enable unattended classification machine learning and classification to usage mapping. The usage pattern associated with the document, the identifier, and the other interactions with the document determined by the collaboration detection module 118 may be stored locally at local storage 108 of the device 102 and/or remotely at the data stores managed by the storage servers 120, or by third party storage services, for example.

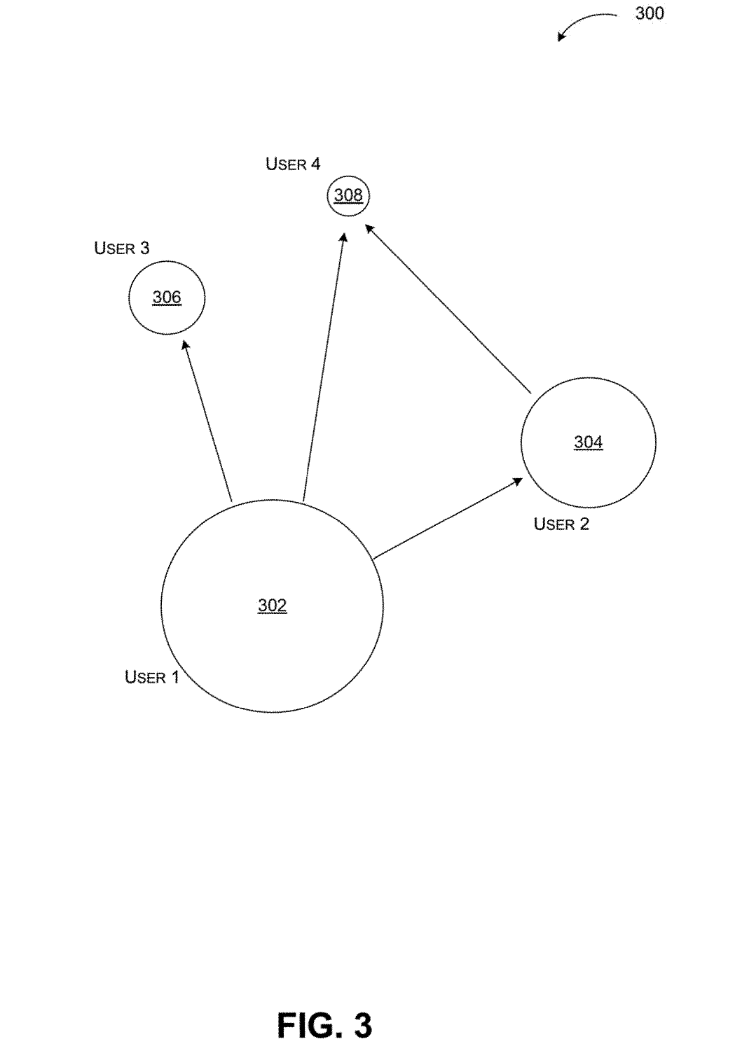

The collaboration detection module 118 may then be configured to provide a recommendation for display through the user experience of the application 106 based on the usage pattern associated with the document, the identifier, and the other interactions with the document. For example, one or more algorithms may be employed to determine the recommendation to provide for display based on the usage pattern associated with the document, the identifier, and the other interactions with the document. In some embodiments, an influence score associated with each user for which a usage pattern is determined, such as the customer 104 and other customers or users 122, may be calculated employing an algorithm, such as a PageRank algorithm, for example. The influence score associated with the customer 104 and the influence score associated with the other customers or users 122 may determine an impact their respective usage patterns have in determining the recommendation to be provided. For example, if the customer 104 has a higher influence score in comparison to the influence score associated with the other customers or users 122, the usage pattern of the customer 104 will have a greater impact or weight in determining the recommendation to be provided. Greater detail about calculation of the influence score is provided in conjunction with FIG. 3 below.

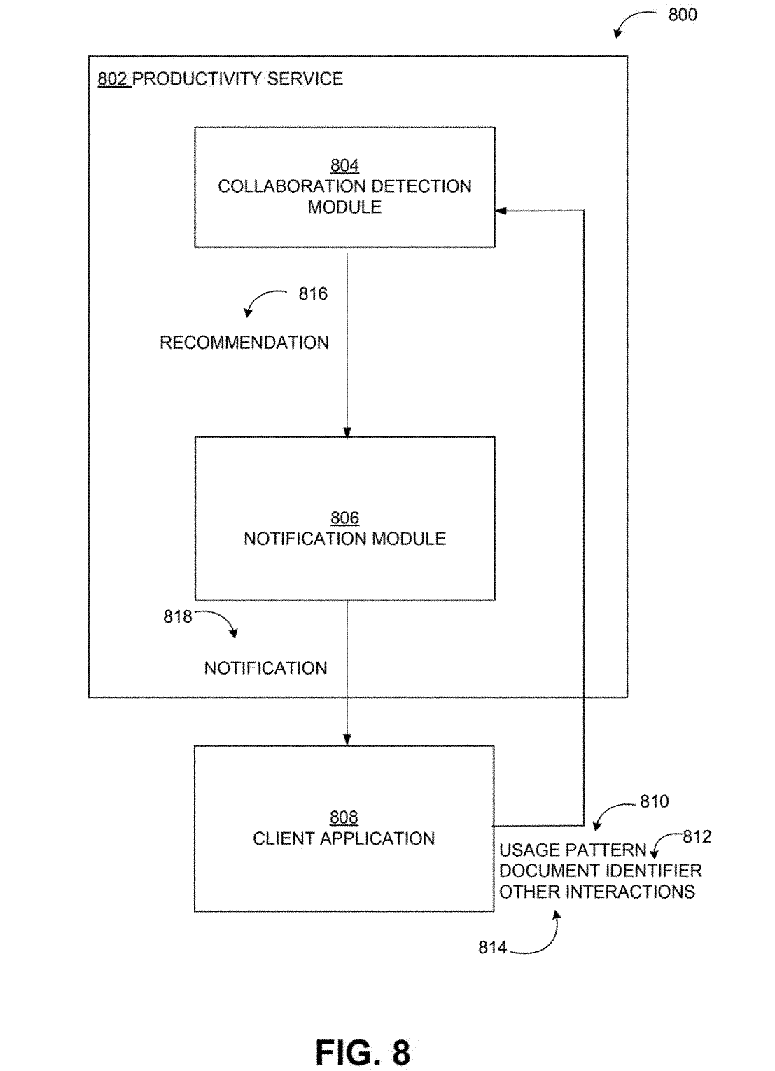

The recommendation may include one or more collaboration tools, not currently implemented by the customer 104, that may expand their collaboration methods and enable them to gain in their productivity. The recommendation may be configured and displayed as a notification through a window, a ribbon, and/or through e-mail, for example, where the customer 104 may be enabled to select one or more of the collaboration tools for implementation through the notification. Additionally, the recommendation may include at least one collaboration network determined based on the usage pattern associated with the document, the identifier, and the other interactions with the document. The customer 104 may be provided an option to select to share the document with the collaboration network through the recommendation. In some embodiments, a separate notification module of the productivity service 114 may configure the recommendation as the notification, and provide the notification for display through the user interface of the application 106 (see FIG. 8 for an example).

The collaboration tools may include communication-based tools, file-sharing tools, co-authoring tools including a real-time typing tool, and/or networking-based tools, among other similar collaboration tools. Example communication-based tools may include the implementation of groups, distribution lists, site and/or shared mailboxes, and public folders. Groups may enable users who are working on a same project, for example, to have a collaborative workspace for messages, files, and/or calendars associated with the project. Distribution lists may enable users to easily send email communications, for example, to a group of recipients with a common interest or characteristic, such as each financial department employee of a company or organization. Site mailboxes may enable users who work together on a project to store project-related documents at a location, such that they are accessible to all project members and to send and receive project-related email communications via the site mailbox. Shared mailboxes may enable several users in a team or organization to share the responsibility of monitoring the mailbox and responding to queries. Public folders may enable archiving and; or sharing of documents, where everyone in an organization, for example, may access and search public folders. Example file sharing tools may enable users interacting with a same document to access the document from a same location such as a cloud based storage system, for example. Each user may be enabled to access and interact with the document through the location, and the updated document may be stored at the location such that when the other users interact with the document they see the latest version. File sharing tools may also provide alerts and/or messages to the users interacting with a document when it is has been edited by another user. Example co-authoring tools may include real-time typing tools that enable users to edit and contribute to a document simultaneously. Each user may be able to see changes to text and formatting in real-time as another user is editing the document such that all users can a stay on the same page as the document evolves Every edit may be synced in the document, and made visible to the other users across a variety platforms and devices without a loss of file fidelity or document formatting. Example networking-based tools enable a user to share and connect with other users by providing information that is most relevant for each user based on the documents they are interacting with and the other users with whom they are engaging.

In a first example scenario, the collaboration detection module 118 may determine that a document has been edited by multiple users (e.g., the customer 104 and the other customers or users 122) but at different times based on the usage pattern associated with the document, the identifier, and the other interactions with the document. Editing of the document by multiple users but at different times may indicate that the multiple users are collaborating on the same document using a traditional method. in other words, they are not implementing collaboration tools and/or features that are available to them. Therefore, the collaboration detection module 118 may be configured to provide a notification, such as a pop-up window, to the users trough the user experience of the application 106, where the notification encourages the users to take advantage of the recommended co-authoring and/or real-time typing collaboration tools when the document is opened next or if the users already have the document open. In a second example scenario, the collaboration detection module 118 may determine that a same document has been both sent and received by the same user (e.g., the customer 104) to different users (e.g., the other customers or users 122) through a communication application, which may be an indication that the user is collaborating with others on the same document. Therefore, the collaboration detection module 118 may be configured to provide a notification, such as an email notification, to the users through the user experience of the application 106, where the notification encourages the users to take advantage of a recommended file-sharing collaboration tool to enable the users to more effectively share and edit the document when the document is opened next or if the users already have the document open.

As previously discussed, a large part of today's productivity involves collaborating with others. While new collaboration features made available through productivity services may provide customers with a rich set of tools to improve their collaboration methods and gain in their productivity, many customers are unaware of the existence of these features. By defining metrics that quantify a degree of collaboration for individual customers and segments of customers employing embodiments, as described in FIG. 1, a quality and effectiveness of the collaboration features may be estimated. These metrics may then aid algorithms to identify customers intending to collaborate and recommend new collaboration features to those customers who are intending to collaborate but are not aware of the features' existence. Additionally, the collaboration detection module may be implemented to provide recommendations for content collaboration consistently across a variety of platforms and devices. Therefore, implementation of a collaboration detection module to provide automatic recommendations for content collaboration may increase efficiency in user interaction, data management, and data presentation collaborative environments across a variety of platforms and devices.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of applications to enable creating, editing, and sharing of collaborative content among customers across multiple different platforms and devices.

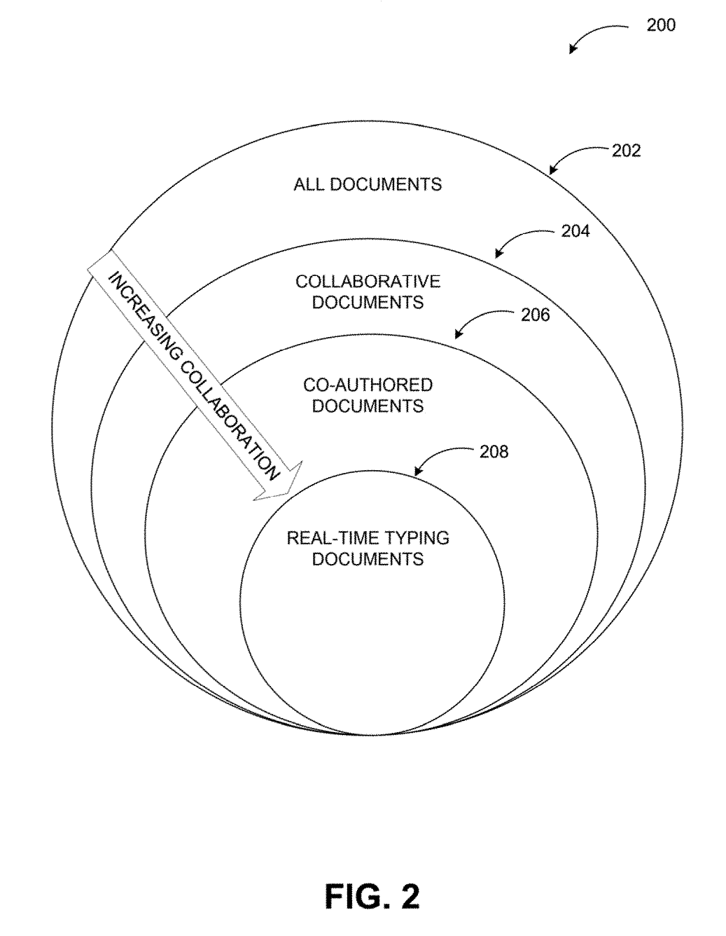

FIG. 2 illustrates a conceptual diagram of example levels of document collaboration. As previously discussed in conjunction with FIGS. 1A-B, a collaboration detection module of a productivity service and/or a third party service may be configured to provide a recommendation for display through an application user experience based on a usage pattern associated with the document, an identifier associated with the document, and other interactions with the document determined by the module. The recommendation may include one or more collaboration tools, not currently implemented by wells) of the document, which may expand their collaboration methods and enable them to gain in their productivity.

As shown in a diagram 200, there may be one or more levels of document collaboration identified by the collaboration detection module based on the usage pattern associated with the document, the identifier, and the other interactions with the document. Example levels may include all documents 202, collaborative documents 204, co-authored documents 206, and real-time typing documents 208. Each level from all documents 202 to real-time typing documents 208 may have increasing collaborative capabilities and/or features.

All documents 202 may employ traditional methods for editing and/or sharing documents among users and may not implement collaborative tools For example, the collaboration detection module may determine that multiple users may edit the document but may do so at different times based on the usage pattern associated with the document, the identifier, and the other interactions with the document. For further example, the collaboration detection module may determine that a same user may both send and receive the document to multiple other users through a communication application to share and allow the other users to edit the document based on the usage pattern associated with the document, the identifier, and the other interactions with the document.

Collaborative documents 204 may implement at least some collaboration tools. For example, the collaboration detection module may determine that users interacting with a same document may be accessing and interacting with the document through a same location, such as a cloud-based storage system, based on the usage pattern associated with the document, the identifier, and the other interactions with the document. The collaboration tools implemented may ensure that once a user is finished editing the document, an updated version of the document may be stored at the location such that when the other users interact with the document they see the latest version.

Co-authored documents 206, in addition to the above-described tools associated with the lower levels of document collaboration, may implement additional collaboration tools. For example, the collaboration detection module may determine that notifications or messages are being sent to each user accessing and interacting with a same document through a same location based on the usage pattern associated with the document, the identifier, and the other interactions with the document. The collaboration tools implemented may enable multiple users associated with a document to work on that document, where content modified by one user may be saved and presented to the other users when ready to be revealed through notification or message, for example.

Real-time typing based documents 208, in addition to the above-described tools associated with the lower levels of document collaboration, may implement real-time typing tools. For example, the collaboration detection module may determine that at least two users are simultaneously accessing and interacting with a same document through a same location based on the usage pattern associated with the document, the identifier, and the other interactions with the document. The collaboration tools implemented may enable the users to edit and contribute to a document simultaneously such that each user may be able to see changes to text and formatting in real-time as another user is editing the document.

The recommendation provided for display by the collaborative detection module may include collaboration tools, not currently implemented by users of the document, that may expand and/or aid in the current level of document collaboration identified by the collaboration detection module. In an example scenario, the collaboration detection module may identify a document at an all documents 202 level of collaboration, where the collaborative users of a document may currently not be implementing any collaboration tools. Therefore, the recommendation may include an option for the users to implement various collaboration tools, such as communication-based tools, file-sharing tools, real-time typing tools, and/or network based tools. Embodiments are not limited to the example levels of document collaboration and scenarios provided above.

FIG. 3 illustrates a conceptual diagram of an influence score implemented to determine a recommendation for content collaboration to be provided. As previously discussed, a collaboration detection module may be configured to provide a recommendation for content collaboration based on a usage pattern of a user associated with the document, an identifier, and other interactions with the document, where the other interactions include usage patterns of other users performing actions on the document associated with the document. In some embodiments, an influence score associated with each user for which a usage pattern is determined may be calculated employing an algorithm, such as a PageRank algorithm, for example. The influence score associated with each user may determine an impact their respective usage patterns may have in determining the recommendation to be provided.

As shown in a diagram 300, a size of the circles representing each user may indicate the impact respective usage patterns of each user may have in determining the recommendation to be provided based on influence scores. For example, Users 1-4 may have previously interacted with and/or are currently interacting with a same document as creators, editors, and/or readers. In some examples, Users 1-4 may comprise a collaboration network. The actions of Users 1-4 in conjunction with the document may be monitored to determine a usage pattern associated with the document for each user. An influence score may then be calculated for each of the Users 1-4 to determine an impact their respective usage patterns may have in determining the recommendation to be provided. User 1 may have a highest influence score 302, User 2 may have a high influence score 304, User 3 may have a low influence score 306, and User 4 may have the lowest influence score 306.

The influence scores for each of the Users 1-4 may be calculated based on a number of outbound connections with other users within the collaboration network, influence scores of other users within the collaboration network, a number of inbound connections with other users within the collaboration network, and an intensity of collaboration. As a number of outbound connections with other users within the collaboration network increases, the influence score may increase. For example, User 1 has three outbound connections, followed by User 2 who has one outbound connection, and Users 3-4 who have no outbound connections. Accordingly, User 1 has the highest influence score 302, User 2 has a high influence score 304, and Users 3-4 have the low influence score 306 and the lowest influence scores 306. While an influence score of a user may be increased by working with another user who has a high influence score, the influence score of the user may consequently be diluted if the user receives influence from the other user. A user receives influence if they have an inbound connection with the other user. Accordingly, a higher number of inbound connections may dilute the influence score. For example, User 4 has two inbound connections, followed by Users 2-3 that have one inbound connection and User 1 who, has no inbound connection. Accordingly, User 4 has the most diluted, and therefore the lowest influence score 308.

Overall, a usage pattern of User 1 may have the greatest impact in determining the recommendation to be provided based on the highest influence score 302 associated with User 1 (followed by the usage patterns of User 2, User 3, and then User 4). In an example scenario, User 1 may be a “super-collaborator” or a user who is at the center of multiple informal networks, in addition to the collaboration network as illustrated. Therefore, as a super-collaborator it is more likely that User 1 will disseminate the information on to appropriate other users and thus amplify the impact of the content and increase the value of the document.

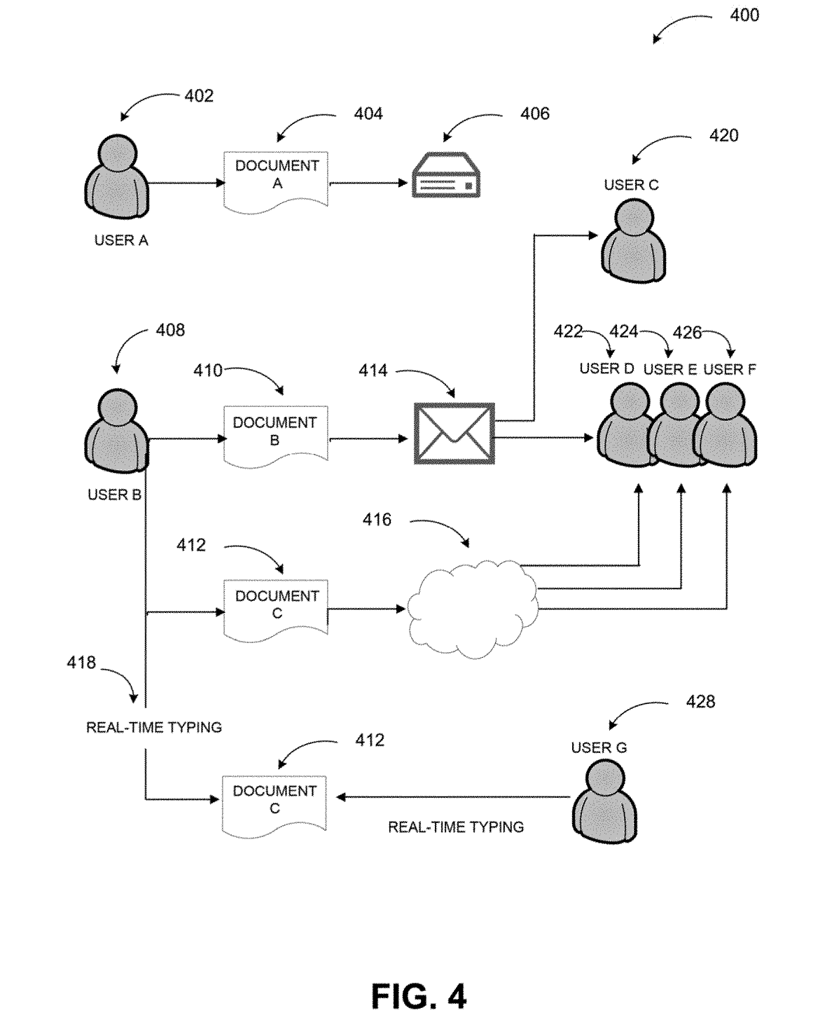

FIG. 4 illustrates example scenarios for automatic provision of recommendations for content collaboration. As shown in diagram 400, multiple users (e.g., Users A-G) may be collaborating with one another to create, edit, and or share various documents (e.g., documents A-D). A collaboration detection module of a productivity service may be configured to provide a recommendation for content collaboration for each document. The recommendation for each document may be based on a usage pattern associated with the document determined from monitored actions, an identifier associated with the document, and other interactions with the document determined by the module, for example. The recommendation may include one or more collaboration tools, not currently implemented by users of the document, which may expand their collaboration methods and enable gain in their productivity. The recommendation tools may include communication-based tools, file-sharing tools, co-authoring tools including a real-time typing tool, and/or networking-based tools, among other collaboration tools.

In a first example scenario, User A 402 may be interacting with document A 404. In response to detecting User A 402 opening the document A 404 through an application associated with the productivity service, the collaboration detection module may be configured to monitor actions performed in conjunction with the document A 404, such as editing, annotating, commenting, sharing, and/or saving of the document A 404, to determine a usage pattern. For example, among other actions, User A 402 may locally save the document A 404 at local storage 406 of a device on which the application is being executed. The collaboration detection module may then be configured to provide a recommendation for the document A 404 based on a usage pattern associated with the document A 404 determined from monitored actions, an identifier associated with the document A 404, and/or other interactions with the document A 404 determined by the module. The recommendation may include a file-sharing collaboration tool for saving the document to a cloud-based storage service, for example, which may provide collaborative advantage over storing the document locally. The recommendation may be provided for display through a user interface of the application and may be provided such that the collaboration tool may be implemented in response to the User A 402 selecting the tool within the recommendation. The recommendation may also include detailed information and/or links to detailed information about the recommended collaboration tool, including the benefits of implementing the recommended tool.

In a second example scenario, User B 408 may be collaborating with User C 420, User D 422, User E 424, and User F 426 on document B 410 through email 414. The collaboration detection module may be configured to monitor actions performed in conjunction with the document B 410, such as editing, annotating, commenting, sharing, and/or saving of the document A 404, to determine a usage pattern. For example, among other actions, User B 408 may both send and receive the document B 410 through a communication application associated with the productivity service, to share the document B 410 with the other users. The collaboration detection module may then be configured to provide a recommendation for the document B 410 based on a usage pattern associated with the document B 410 determined from monitored actions, an identifier associated with the document B 410, and/or other interactions with the document B 410 determined by the module. The recommendation may include communication-based and/or file-sharing collaboration tools, for example, such that each of the users, User B 408, User C 420, User 422, User E 424, and User F 426 may be enabled to access and interact with the document B 410 at a same location, such as a cloud-based storage or collaboration service, which may provide collaborative advantages over back and forth email communications. The content of the document B 410 modified or edited by each of the users may be saved at the same location and presented to the other users when ready to be revealed, where alerts or messages may also be sent to the each of the users when such modifications or edits to document B 410 have been made.

In a third example scenario, User B 408 may be collaborating with User D 422, User E 424, User F 426, and User G 428 on document C 412. Document C 412 may be saved and collaborated on using a cloud-based storage and/or collaboration service 416, for example. However, the collaboration detection module may detect that User B 408 and User G 428 are interacting with the document C at a frequency above a particular threshold, based on the determined usage pattern and/or monitored actions. In response, the collaboration detection module may then be configured to provide a recommendation for the document C 412, where the recommendation may include a real-time typing 418 collaboration tool for the document C 412. The real-time typing 418 collaboration tool may enable User B 408 and User G 428 to view edits being made/make edits themselves to the document C 412 in real-time such that a simultaneous authoring session is created among User B 408 and User G 428.

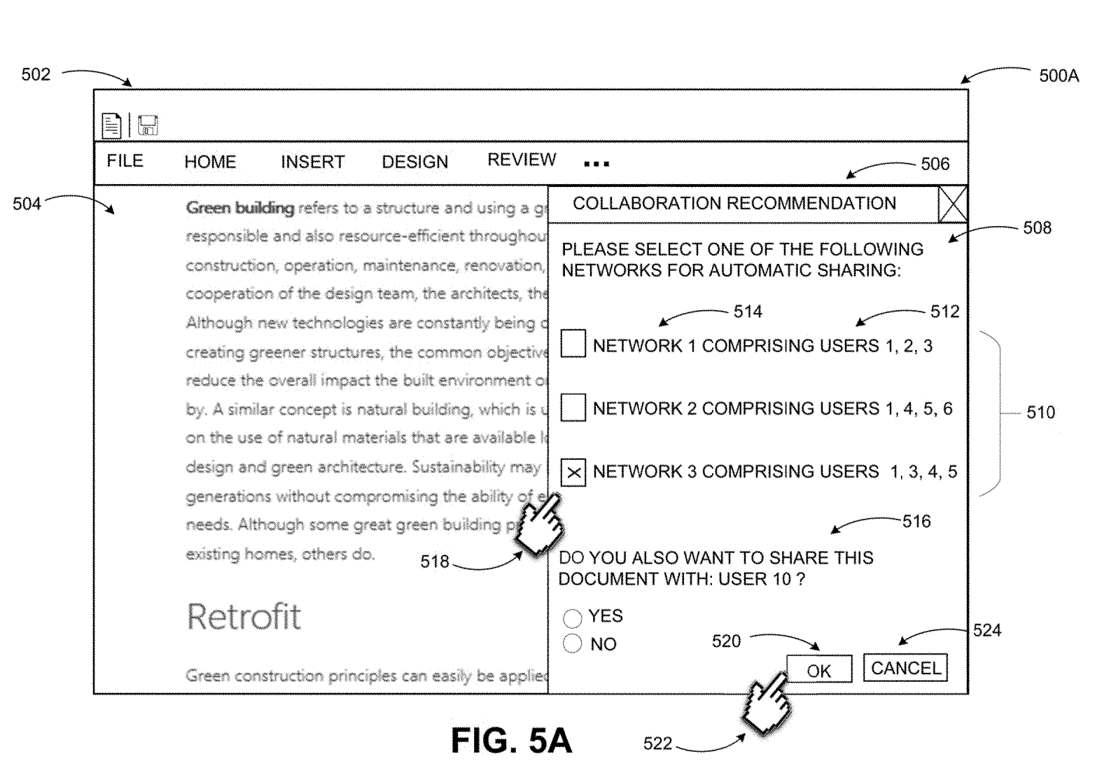

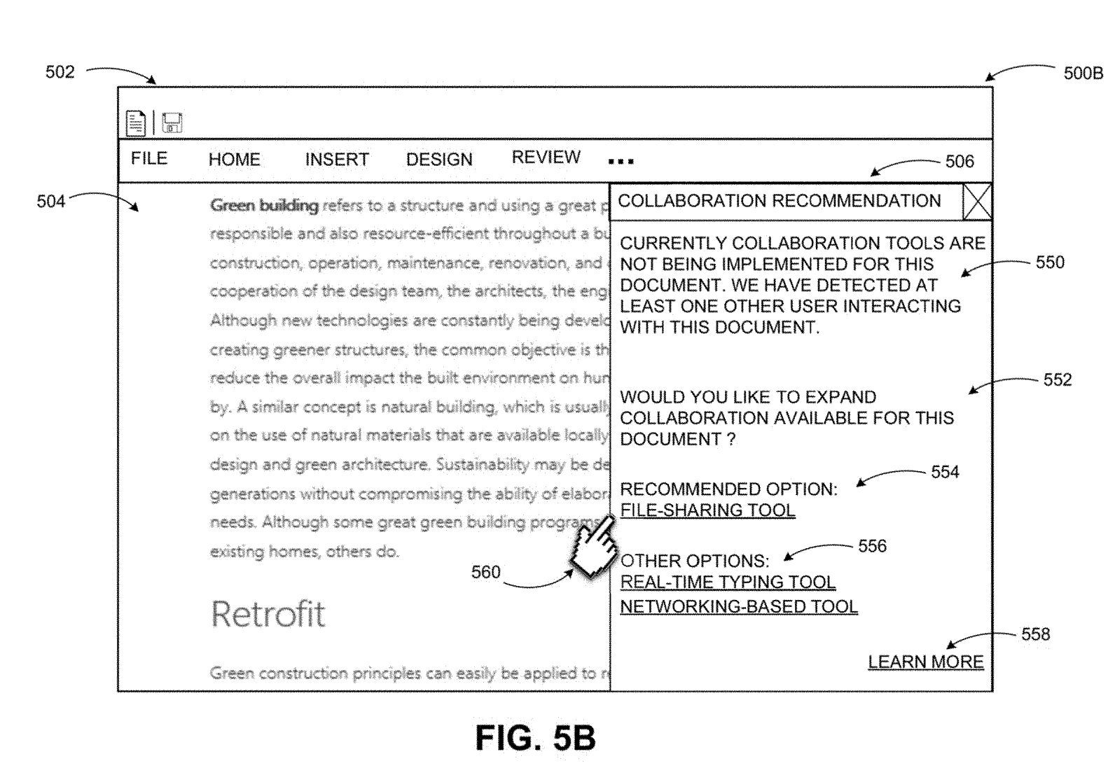

FIGS. 5A-B illustrate recommendations configured as window notifications. As shown in a diagram 500A of FIG. 5A and 500B of FIG. 5B, a user may open a document 504 through an application executing on a computing device of the user, where the document may be displayed through a user experience 502 of the application. The document 504 may be a word-processing document associated with a productivity service, for example, that one or more other users are collaborating on.

In response to detection of the opening of the document 504, a collaboration detection module of the productivity service may be configured to monitor one or more actions performed in conjunction with the document to determine a usage pattern associated with the document. The collaboration module may also be configured to determine an identifier associated with the document, and determine other interactions with the document based on the identifier. The collaboration module may then be configured to provide a recommendation for display through the user experience 502 based on the usage pattern associated with the document, the identifier, and the other interactions with the document. The recommendation may include at least one collaboration network for automatic sharing of the document 504 as shown in diagram 500A, and one or more collaboration tools, as shown in diagram 500B. As illustrated, the recommendation may be configured and displayed as a window notification 506 through the user experience 502. The window notification 506 may be a pop-up window, a drop-down window, or a fly-out window, for example.

As shown in a diagram 500A, the window notification 506 may initially include a main instruction 508 associated with automatic sharing of the document 504 and one or more selections 510 in response to the main instruction 508. The main instruction 508 may prompt the user to select a network for automatic sharing of the document. Each of the selections 510 may include a network 514 recommended for automatic sharing of the document 504 and one, or more, users 512 that form the network 514. The window notification may also include an option 516 to share the document 504 with other missing or forgotten users that are not a part of the recommended networks, for example. Similar to the recommended networks, these other users may also be determined based on the usage pattern associated with the document, the identifier, and the other interactions with the document. After a user selects 518 one or more of the selections 510, the user may select 522 an “OK” command 520. Alternatively, the user may select a “Cancel” command 524 if the user does not wish to automatically share with a network and/or other user.

In response to either a user selection of the “OK” command 520 or the “Cancel” command 524, content of the window notification 506 may be replaced with a prompt 550 and a main instruction 552 associated with recommended collaboration tools, as shown in the diagram 500B. in other embodiments, this may be the initial and/or only content displayed within the window notification 506. The prompt 550 may indicate to the user which collaboration tools are currently being implemented and/or why the recommendation for content collaboration is being provided. For example, if the collaboration detection module detects editing of the document 504 by multiple users but at different times based on the usage pattern, identifier, and other interactions, the prompt 550 may indicate that limited or no collaboration tools are being implemented for the document 504. The prompt 550 may also indicate that this recommendation is being provided because other users have been detected interacting with the document, and thus the users may benefit from the implementation of available collaboration features. The main instruction 552 may pose to the user whether or not be/she would like to expand the collaborative features available for the document 504. At least one collaboration tool 554 may be recommended. In some embodiments, additional options for collaboration tools 556 may also be provided. For more information on the recommended collaboration tool 554 and/or other options for collaboration tools 556, the user may select a link 558 to a site comprising more detailed information. In other embodiments, the window notification 506 may also include another prompt containing information regarding the benefit of employing the recommended collaboration tool 554 and/or additional options for collaboration tools 556. The user may then be enabled to select 560 the recommended collaboration tool 554 and/or additional options for collaboration tools 556 for implementation through the window notification 506.

Embodiments are not limited to the configuration of the window notification 506 as illustrated in FIGS. 5A-B. The window notification 506 may be displayed using a textual scheme, a graphical scheme, an audio scheme, an animation scheme, a coloring scheme, a highlighting scheme, and/or a shading scheme to enhance the display within the user experience 502, for example.

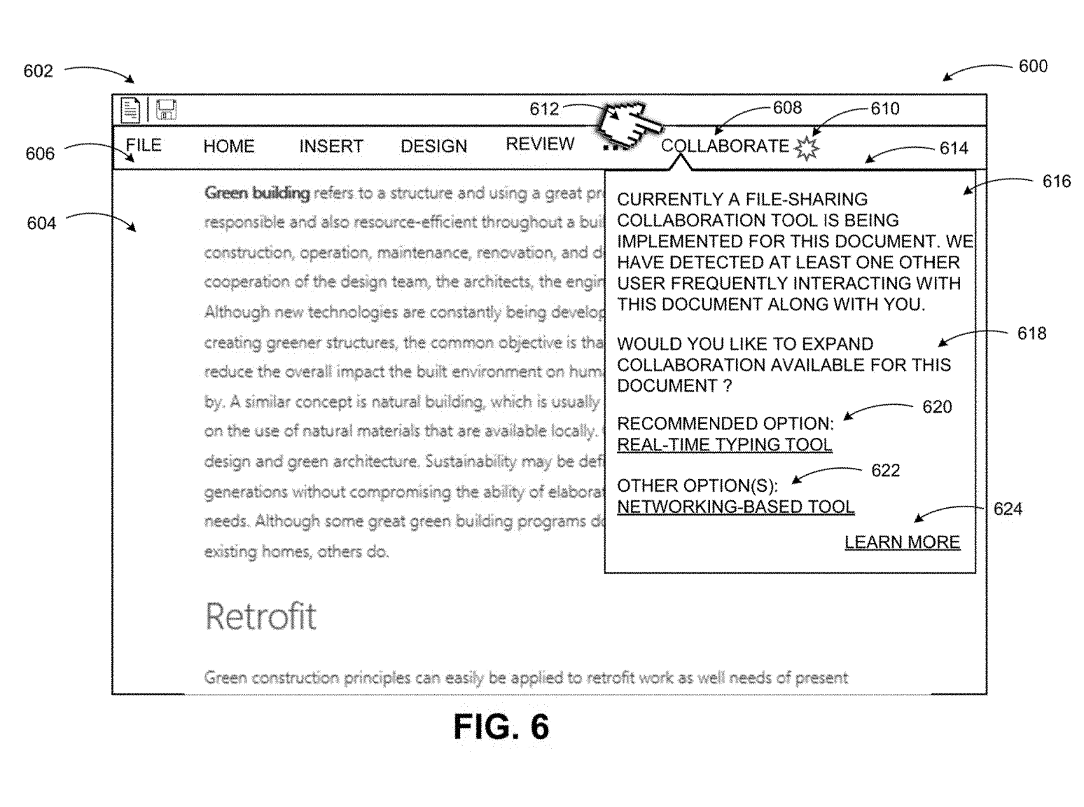

FIG. 6 illustrates a recommendation configured as a ribbon notification As shown in a diagram 600, a user may open a document 604 through an application executing on a computing device of the user, where the document may be displayed through a user experience 602 of the application. The user experience 602 may include a ribbon and/or tool bar 606 comprising one or more tabs, where one of the tabs may be a collaborate tab 608, for example. The document 604 may be a word-processing document associated with a productivity service, for example, that one or more other users may be collaborating on.

In response to detection of the opening of the document 604, a collaboration detection module of the productivity service may be configured to monitor one or more actions performed in conjunction with the document to determine a usage pattern associated with the document. The collaboration module may also be configured to determine an identifier associated with the document, and determine other interactions with the document based on the identifier. The collaboration module may then be configured to provide a recommendation for display through the user experience 602 based on the usage pattern associated with the document, the identifier, and the other interactions with the document, where the recommendation includes one or more collaboration tools. As illustrated, the recommendation may be configured and displayed as a ribbon notification 614 in conjunction with the collaborate tab 608. The ribbon notification may include a graphical icon 610, such as a star, adjacent to the collaborate tab 608 that alerts the user to a new notification, as illustrated, in some examples, the graphical icon 610 may be animated to further draw the user's attention. in response to a user selection 612 of the graphical icon 610 and/or the collaborate tab 608, the ribbon notification 614 may be displayed.

The ribbon notification 614 may include a prompt 616 and a main instruction 618. The prompt 616 may indicate to the user what collaboration tools are currently being implemented and/or why the recommendation for content collaboration is being provided. For example, if the collaboration detection module detects that the document is saved through a cloud-based storage service accessible to the other users collaborating on the document 604, the prompt 616 may indicate file-sharing, collaboration tools are being implemented for the document 604 and that this recommendation is being provided because more frequent interaction with the document among the users has been detected which may be benefitted by additional collaboration features. The main instruction 618 may pose to the user whether or not be/she would like to expand the collaborative features available, for the document 604. At least one collaboration tool 620 may be recommended. In some embodiments, additional options for collaboration tools 622 may also be provided. For more information on the recommended collaboration tool 620 and/or additional options for collaboration tools 622, the user may select link 624 to a site comprising more detailed information. In other embodiments, the ribbon notification 614 may also include another prompt containing information regarding the benefit of employing the recommended collaboration tool 620 and/or additional options for collaboration tools 622. The user may then be enabled to select the recommended collaboration tool 620 and/or additional options for collaboration tools 622 for implementation through the ribbon notification 614.

Embodiments are not limited to the configuration of the ribbon notification 614 as illustrated in FIG. 6. The ribbon notification 614 may be displayed using a textual scheme, a graphical scheme, an audio scheme, an animation scheme, a coloring scheme, a highlighting scheme, and/or a shading scheme to enhance the display within the user experience 602, for example.

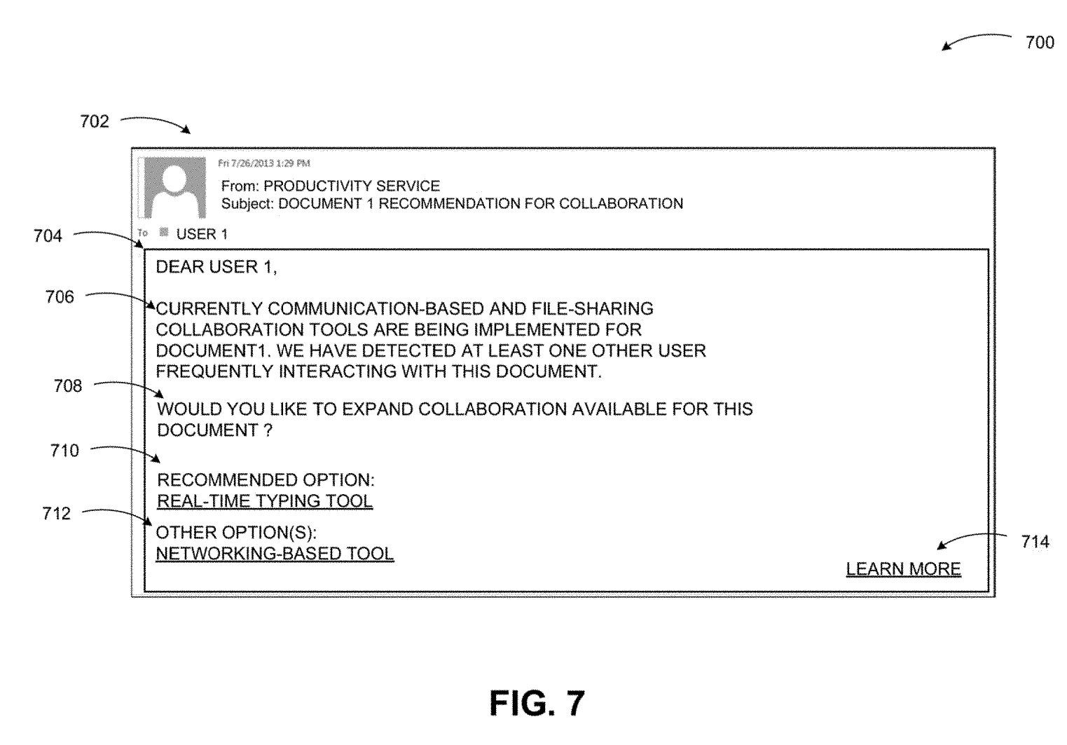

FIG. 7 illustrates a recommendation configured as an email notification. As previously discussed, in response to detection of an opening of a document, a collaboration detection module may be configured to monitor one or more actions performed in conjunction with the document to determine a usage pattern associated with the document. The collaboration module may also be configured to determine an identifier associated with the document, and determine other interactions with the document based on the identifier. The collaboration module may then be configured to provide a recommendation for display based on the usage pattern associated with the document, the identifier, and the other interactions with the document, where the recommendation includes one or more collaboration tools. As shown in a diagram 700, the recommendation may be configured and displayed as an email notification 704. A user associated with the document may receive an email message 702 through a communication application executing on a computing device of the user, where the email message 702 may include the email notification 704.

The email notification 704 may include a prompt 706 and a main instruction 708. The prompt 706 may indicate to the user what collaboration tools are currently being implemented and/or why the recommendation for content collaboration is being provided. For example, if the collaboration detection module detects that the document is saved through a cloud-based storage service accessible to the other users collaborating on the document, and each user is notified through email message when a change is made to the document, the prompt 706 my indicate that file-sharing and communication-based collaboration tools are being implemented for the document. The prompt 706 may also include that this recommendation is being provided because more frequent interaction with the document among the users has been detected which may be benefited by additional collaboration features. The main instruction 708 may pose to the user whether or not be/she would like to expand the collaborative features available for the document. At least one collaboration tool 710 may be recommended. In some embodiments, additional options for collaboration tools 712 may also be provided. For more information on the recommended collaboration tool 710 and/or additional options for collaboration tools 712, the user may select a link 714 to a site comprising more detailed information. In other embodiments, the email notification 704 may also include another prompt containing information regarding the benefit of employing the recommended collaboration tool 710 and/or additional options for collaboration tools 712. The user may then be enabled to select the recommended collaboration tool 710 and/or one of the additional options for collaboration tools 712 for implementation through the email notification 704.

FIG. 8 illustrates an example service and integrated modules of the service configured to automatically provide recommendations for content collaboration.

As shown in a diagram 800, a productivity service 802 may be configured to enable one or more users to create, edit, present, and/or share content, such as documents associated with the productivity service 802. The documents may include a word-processing document, a presentation document, a spreadsheet document, a communication document, and/or a notebook document, for example. The productivity service may include a collaboration detection module 804 and a notification module 806, as illustrated. In other embodiments, the collaboration detection module 804 and the notification module 806 may be integral modules of a third party service. In further embodiments, the collaboration detection module 804 and the notification module 806 may be incorporated into a single module (e.g., the collaboration detection module 118 described in conjunction with FIG. 1). As described herein, the collaboration detection module 804 and the notification module 806 may be implemented as software, hardware, or combinations thereof.

A user may execute a locally installed client application 808 through a device with which the productivity service 802 may be configured to integrate and interoperate with over one or more networks. In other embodiments, the user may execute a thin (e.g., a web browser) version of the application. In response to detection of an opening of a document through a user experience of the client application 808, the collaboration detection module 804 may be configured to monitor one or more actions performed in conjunction with the document to determine a usage pattern 810 associated with the document. For example, the monitored actions may include editing, annotating, commenting, sharing, anchor saving of the document by the user, and the usage pattern may include a frequency at which the user interacts with the document, the types of actions the user performs on the document, and a frequency of those specific types of actions.

The collaboration detection module 804 may also be configured to determine an identifier 812 associated with the document The identifier 812 may include information associated with the creation, editing, and/or sharing of the document, such as all users who have interacted with the document, a frequency at which the users interacted with the document, and relationships between the users who have interacted with the document. Additionally, the identifier may include any tags associated with the document, a content type of the document, other documents related to the document, and/or any other attributes of the documents, among other examples. The collaboration detection module 804 may further be configured to determine other interactions 814 with the document based on the identifier. For example, usage patterns associated with the document for other customers or users who may be collaborating on the document.

The collaboration detection module 804 may then be configured to provide a recommendation 816 fix display through the user experience of the client application 808 based on the usage pattern 810 associated with the document, the identifier 812, and the other interactions 814 with the document. For example, the collaboration detection module 804 may employ one or more algorithms to determine the recommendation 816 to provide for display based on the usage pattern 810 associated with the document, the identifier 812, and the other interactions 814 with the document. The recommendation 816 may include one or more collaboration tools, not currently implemented by the user, that may expand their collaboration methods and enable gain in their productivity. The collaboration tools may include communication-based tools, file-sharing tools, co-authoring tools including a real-time typing tool, and/or networking-based tools, among other collaboration tools. Additionally, the recommendation 816 may include at least one collaboration network recommended for automatic sharing of the document, where the collaboration network may be determined based on the usage pattern associated with the document, the identifier, and the other interactions with the document.

The notification module 806 may be configured to receive the recommendation 816 from the collaboration detection module 804, and configure the recommendation 816 as a notification 818 for display through the user experience of the client application 808. The notification module 806 may configure the recommendation 816 as a window notification, a ribbon notification, or e-mail notification, for example. The notification module 806 may also configure the notification 818 for display such that the user may be enabled to select one or more of the collaboration tools within the notification to implement the selected tools and/or to select to automatically share the document with the collaboration network through the user experience of the client application 808. The notification 818 may also include detailed information and/or links to detailed information about the collaboration tools, including the benefits of implementing those tools.

The examples provided in FIGS. 1 through 8 are illustrated with specific systems, services, modules, and recommendation configurations. Embodiments are not limited to environments according to these examples. Provision of automatic recommendations for content collaboration may be implemented in environments employing fewer or additional systems, services, modules, and recommendation configurations. Furthermore, the example systems, services, modules, and recommendation configurations shown in FIG. 1 through 8 may be implemented in a similar manner with other values using the principles described herein.

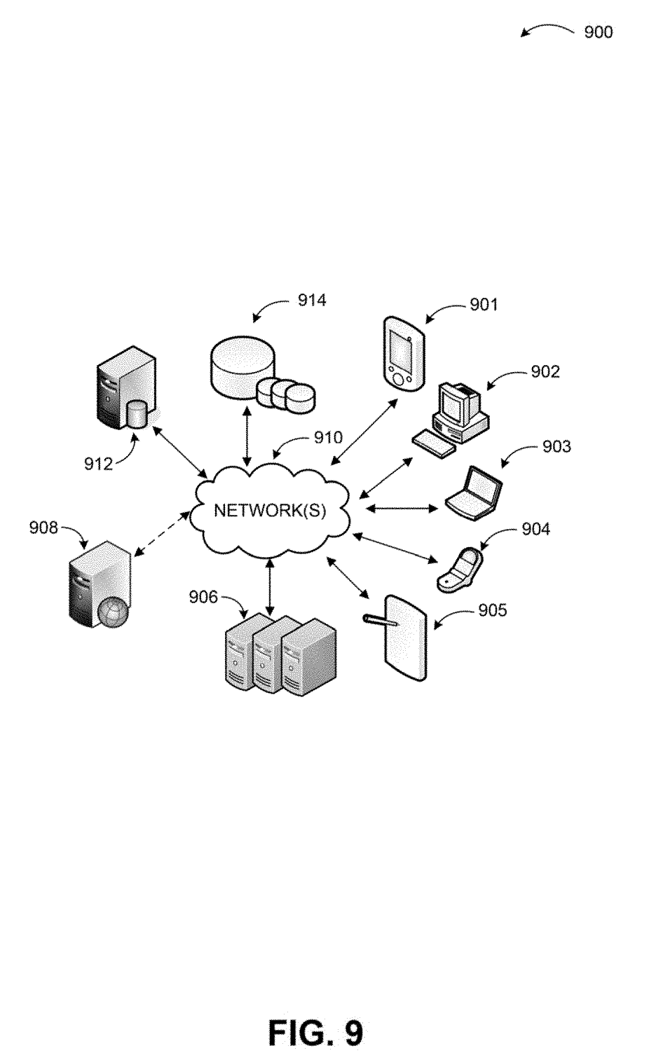

FIG. 9 is a networked environment, where a system according to embodiments may be implemented. In addition to locally installed applications (for example, application 106), a collaboration detection module and/or notification module also be employed in conjunction with hosted applications and services (for example, the productivity service 114) that may be implemented via software executed over one or more servers 906 or individual server 908, as illustrated in diagram 900. A hosted service or application may communicate with client applications on individual computing devices such as a handheld computer 901, a desktop computer 902, a laptop computer 903, a smart phone 904, a tablet computer (or slate), 905 (‘client devices’) through network(s) 910 and control a user interface presented to users.

Client devices 901-905 are used to access the functionality provided by the hosted service or application. One or more of the servers 906 or server 908 may be used to provide a variety of services as discussed above. Relevant data may be stored in one or more data stores (e.g. data store 914), which may be managed by any one of the servers 906 or by database server 912.

Network(s) 910 may comprise any topology of servers, clients, Internet service providers, and communication media. A system according to embodiments may have a static or dynamic topology. Network(s) 910 may include a secure network such as an enterprise network, an unsecure network. such as a wireless open network, or the Internet. Network(s) 910 may also coordinate communication over other networks such as PSTN or cellular networks. Networks) 910 provides communication between the nodes described herein. By way of example, and not limitation, network(s) 910 may include wireless media such as acoustic, RF, infrared and other wireless media.

Many other configurations of computing devices, applications, engines, modules, data sources, and data distribution systems may be employed for providing automatic recommendations for content collaboration. Furthermore, the networked environments discussed in FIG. 9 are for illustration purposes only. Embodiments are not limited to the example applications, engines, modules, or processes.

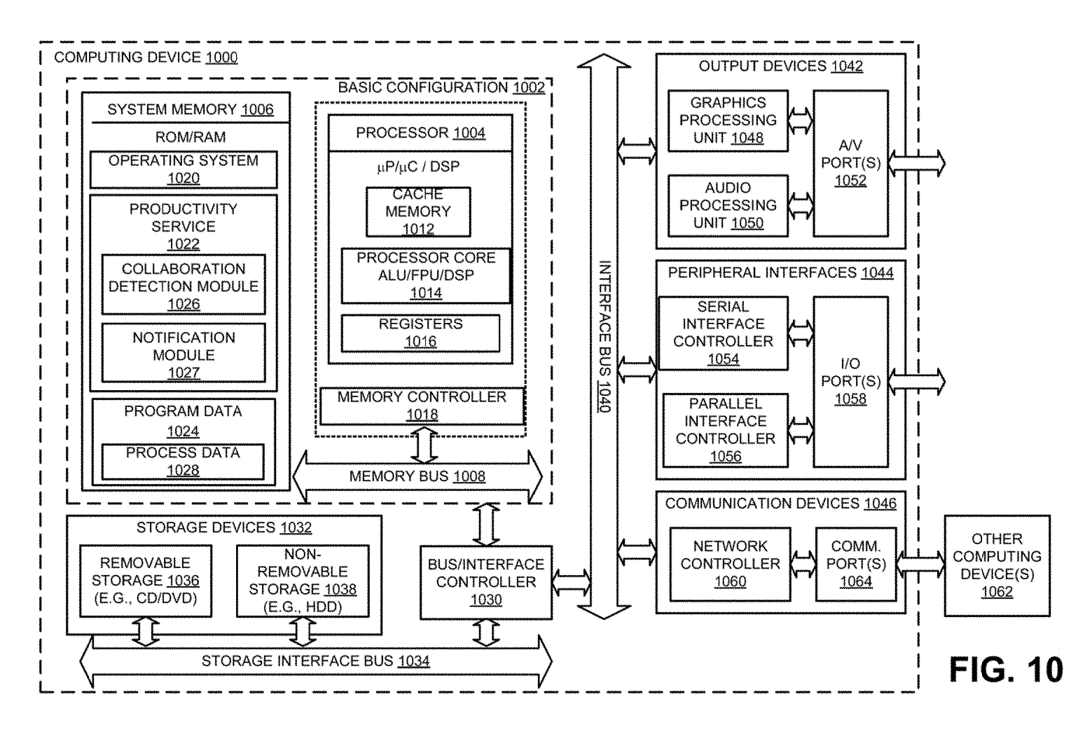

FIG. 10 is a block diagram of an example general purpose computing device, which may be used to automatically provide recommendations for content collaboration.

For example, computing device 1000 may be used as a server, desktop computer, portable computer, smart phone, special purpose computer, or similar device. In an example basic configuration 1002, the computing device 1000 may include one or more processors 1004 and a system memory 1006. A memory bus 1008 may be used for communicating between the, processor 1004 and the system memory 1006. The basic. configuration 1002 is illustrated in FIG, 10 by those components within the inner dashed line.

Depending on the desired configuration, the processor 1004 may be of any type, including but not limited to a microprocessor (μP), a microcontroller (μC), a digital signal processor (DSP), or any combination thereof The processor 1004 may include one more levels of caching, such as a level cache memory 1012, one or more processor cores 1014, and registers 1016. The example processor cores 1014 may teach) include an arithmetic logic unit (ALU), a floating point unit (FPU), a digital signal processing core (DSP Core), or any combination thereof An example memory controller 1018 may also be used with the processor 1004, or in some implementations the memory controller 1018 may be an internal part of the processor 1004.

Depending on the desired configuration, the system memory 1006 may be of any type including but not limited to volatile memory (such as RAM), non-volatile memory (such as ROM, flash memory, etc.) or any combination thereof. The system memory 1006 may include an operating system 1020, a productivity service 1022, and program data 1024. The productivity service 1022 may include a collaboration detection module 1026 and a notification module 1027, which may be integrated modules of the productivity service 1022. In other embodiments, the collaboration detection module 1026 and the notification module 1.027 may be a single integrated module of the productivity service 1022. The collaboration detection module 1026 may be configured to monitor one or more actions performed in conjunction with a document to determine a usage pattern associated with the document in response to detection of an opening of a document through an application user experience. The collaboration detection module 1026 may also be configured to determine an identifier associated with the document and determine other interactions with the document based on the identifier. The collaboration detection module 1026 may then be configured to provide a recommendation may to be displayed through the application user experience based on the usage pattern associated with the document, the identifier, and the other interactions with the document, where the recommendation includes one or more collaboration tools. The notification module 1027 may configure the recommendation as a notification for display. The program data 1024 may include, among other data, process data 1028, such as usage patterns associated with one or more users, document identifiers, and interactions with the document, and as described herein.

The computing device 1000 may have additional features or functionality, and additional interfaces to facilitate communications between the basic configuration 1002 and any desired devices and interfaces. For example, a bus/interface controller 1030 may be used to facilitate communications between the basic configuration 1002 and one or more data storage devices 1032 via a storage interface bus 1034. The data storage devices 1032 may be one or more removable storage devices 1036, one or more non-removable storage devices 1038, or a combination thereof Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology fix storage of information, such as computer readable instructions, data structures, program modules, or other data.

The system memory 1006, the removable storage devices 1036 and the non-removable storage devices 1038 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 1000. Any such computer storage media ma be part of the computing device 1000.

The computing device 1000 may also include an interface bus 1040 for facilitating communication from various interface devices (for example, one or more output devices 1042, one or more peripheral interfaces 1044, and one or more communication devices 1046) to the basic configuration 1002 via the bus/interface controller 1030. Some of the example output devices 1042 include a graphics processing unit 1048 and an audio processing unit 1050, which may be configured to communicate to various external devices such as a display or speakers via one or more A/V ports 1052. One or more example peripheral interfaces 1044 may include a serial interface controller 1054 or a parallel interface controller 1056. which may be configured to communicate with external devices such as input devices (for example, keyboard, mouse, pen, voice input device, touch input device, etc.) or other peripheral devices (for example, printer, scanner, etc.) via one or more I/O ports 1058. An example communication device 1046 includes a network controller 1060, which may be arranged to facilitate communications with one or more other computing devices 1062 over a network. communication link via one or more communication ports 1064. The one or more other computing devices 1062 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 1000 may be implemented as a part of a general purpose or specialized server, mainframe, or similar computer that includes any of the above functions. The computing device 1000 may also be implemented as a personal computer including both laptop computer and non-laptop computer configurations.

Example embodiments may also include methods to automatically provide recommendations for content collaboration. These methods can be implemented in any number of ways, including, the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

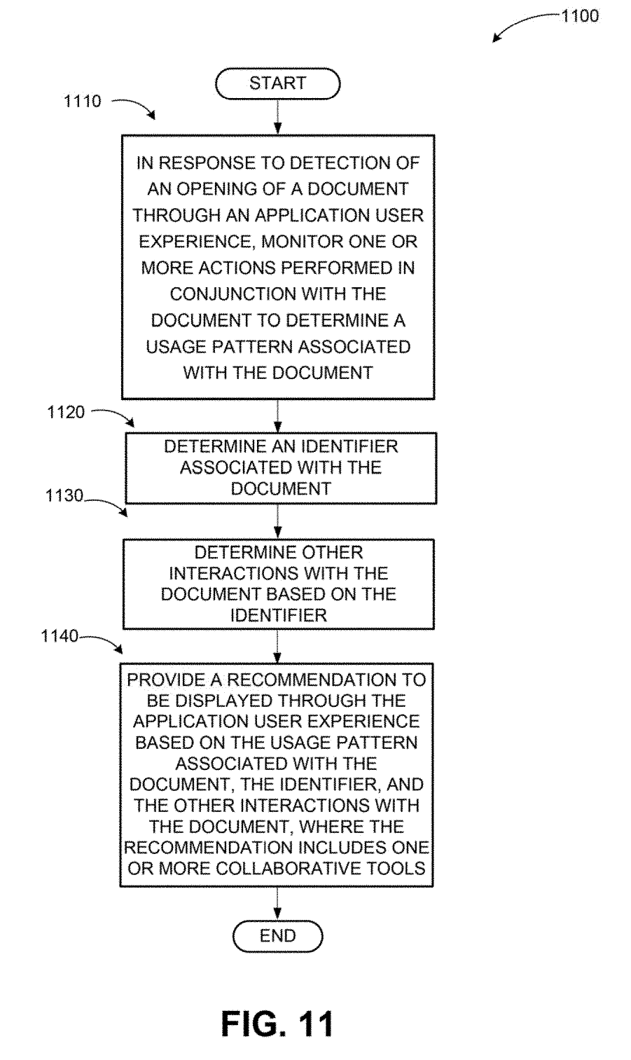

FIG. 11 illustrates a logic flow diagram of a method to automatically provide recommendations for content collaboration, according to embodiments.

Process 1100 may be implemented on a computing device, server, or other system, An example system may include a server that includes, among other components, one or more processors configured to execute a collaboration detection module and/or a notification module. The collaboration detection module and/or notification module may be integrated modules of a productivity service or a third party service hosted by the server.

Process 1100 begins with operation 1110, where the collaboration detection module may be configured to, monitor one or more actions performed in conjunction with a document to determine a usage pattern associated with the document in response to detection of an opening of a document through an application user experience. For example, the monitored actions may include editing, annotating, commenting, sharing, and/or saving of the document by a user. In some embodiment, the collaboration detection module may be configured to filter the monitored actions based on a length and/or type of action such that non -relevant and/or “accidental” actions may not be included in the determination of the usage pattern. The usage pattern associated with the document may include a frequency at which a user interacts with the document, types of actions a user performs on the document, and/or a frequency of those specific types of actions, for example.

At operation 1120, the collaboration detection module may also be configured to determine an identifier associated with the document The identifier may include information associated with the creation, editing, and/or sharing of the document, such as all users who have interacted with the document, a frequency at which the users interacted with the document, and relationships between the users who have interacted with the document. Additionally, the identifier may include any tags associated with the document, a content type of the document, other documents related to the document, and/or any other attributes of the documents, among other examples. At operation 1130, the collaboration detection module may further be configured to determine other interactions with the document based on the identifier. For example, the collaboration detection module may be configured to determine usage patterns associated with the document for other customers or users. The usage patterns may be determined in a similar manner as described above in conjunction with operation 1110 (that is, by monitoring actions of the other customers or users in conjunction with the document).

At operation 1140, the collaboration detection module may then be configured to provide a recommendation to be displayed through the application user experience based on the usage pattern associated with the document, the identifier, and the other interactions with the document, where the recommendation includes one or more collaboration tools. In some examples, the collaboration detection module may be configured to employ one or more algorithms to determine the recommendation be provided for display based on the usage pattern associated with the document, the identifier, and the other interactions with the document. The collaboration tools included within the recommendation may be tools not currently implemented, by the customer that may expand their collaboration methods and enable them to gain in their productivity. The communication tools may include communication-based tools, file-sharing tools, co-authoring tools including a real-time typing tool, and/or networking-based tools, for example. Additionally, the recommendation may include at least one collaboration network recommended for automatic sharing of the document, where the collaboration network may be determined based on the usage pattern associated with the document, the identifier, and the other interactions with the document in some embodiments, the notification module may be configured to configure the recommendation as a notification such that the recommendation is provided fir display as a window, a ribbon notification, and/or an e-mail notification, for example. A user may then be enabled to select one or more of the collaboration tools for implementation or to select the collaboration network for automatic sharing of the document through the notification displayed within the application user experience.

The operations included in process 1100 are for illustration purposes. Automatically providing recommendations for content collaboration may be implemented by similar processes with fewer or additional steps. as well as in different order of operations using the principles described herein. The operations described herein may be executed by one or more processors operated on one or more computing devices, one or more processor cores, specialized processing devices, and/or general purpose processors, among other examples.

According to some embodiments, means to provide suggestions for content collaboration are provided. Example means may include a means for monitoring one or more actions performed in conjunction with the document to determine a usage pattern associated with the document in response to detecting an opening of a document through an application user experience, a means for determining an identifier associated with the document, and a means for determining other interactions with the document based on the identifier. The example means may also include a means for providing a recommendation to be displayed through the application user experience based on the usage pattern associated with the document, the identifier, and the other interactions with the document, where the recommendation includes one or more collaboration tools.

According to some examples, methods to provide suggestions for content collaboration are provided. An example method may include monitoring one or more actions performed in conjunction with the document to determine a usage pattern associated with the document in response to detecting an opening of a document through an application user experience, determining an identifier associated with the document, and determining other interactions with the document based on the identifier. The example method may also include providing a recommendation to be displayed through the application user experience based on the usage pattern associated with the document, the identifier, and the other interactions with the document, where the recommendation includes one or more collaboration tools.

In other examples, a usage pattern of one or more other users associated with the document may be determined by monitoring one or more actions of the other users performed in conjunction with the document. Thee recommendation may be further provided based on the usage pattern of the other users. An influence score associated with each user for which a usage pattern is determined may be calculated, where the influence score may determine an impact the usage pattern for each user has in determining the recommendation to be provided. The actions may be filtered based on a type of action and a length of action. The recommendation may be provided for display such that a user is enabled to select one or more of the collaboration tools included in the recommendation through the application user experience to implement the selected collaboration tools. The recommendation may be configured as a notification, and the notification may be provided to be displayed as a window notification, an email notification, or a ribbon notification.

In further examples, at least one collaboration network may be determined based on the usage pattern associated with the document, the identifier, and the other interactions with the document. An option to select to share the document with the at least one collaboration network may be provided within the recommendation. The identifier may include users who have interacted with the document, a frequency at which the users interacted with the document, relationships between the users who have interacted with the document, tags associated with the document, a content type of the document, attributes of the documents, and/or other documents related to the document. The usage pattern may include a frequency at which a user interacts with the document, types of actions the user performs on the document, and/or a frequency at which each of the types of actions is performed on the document by the user. The communication tools may include communication-based tools, file-sharing tools, co-authoring tools, real-time typing tools, and networking-based tools.

According to some embodiments, servers to provide recommendations for content collaboration may be described. An example server may include a memory configured to store instructions and one or more processors coupled to the memory, where the processors may be configured to execute, in conjunction with the instructions stored in the memory, a collaboration detection module. The collaboration detection module may be configured to monitor one or more actions performed in conjunction with the document to determine a usage pattern associated with the document in response to detection of an opening of a document associated with a productivity service through an application user experience, determine an identifier associated with the document, and determine other interactions with the document based on the identifier. The collaboration detection module may also be configured to provide a recommendation to be displayed through the application user experience based on the usage pattern associated with the document, the identifier, and the other interactions with the document, where the recommendation includes one or more collaboration tools.

In other embodiments, one or more algorithms may be employed by the collaboration detection module to determine the recommendation to provide for display based on the usage pattern associated with the document, the identifier, and the other interactions with the document. The one or more processors, in conjunction with the instructions stored in the memory, may be further configured to execute a notification module to configure the recommendation as a window notification, an email notification, or a ribbon notification to be displayed through the application user experience. The collaboration detection module may be configured to provide the recommendation to be displayed through the application user experience such that the recommendation is displayed consistently across a plurality of platforms and devices.

In further embodiments, the monitored actions may include editing, annotating, commenting, sharing, and/or saving of the document. The collaboration detection module may be an integral module of a productivity service or a third party service. The document may be a word-processing document, a presentation document, a spreadsheet document, a communication document, and/or a notebook document.

According to some examples, computer-readable memory devices with instructions stored thereon to provide recommendations for content collaboration may be described. Example instructions may include monitoring one or more actions performed in conjunction with the document to determine a usage pattern associated with the document in response to detecting, an opening of a document through an application user experience; determining an identifier associated with the document, and determining other interactions with the document based on the identifier. The example instructions may also include providing a recommendation to be displayed through the application user experience based on the usage pattern associated with the document, the identifier, and the other interactions with the document, where the recommendation includes one or more collaboration tools and implementation of the collaboration tools is enabled in response to a selection of the recommendation through the application user experience.

In other examples, a usage pattern of one or more other users associated with the, document may be determined. The recommendation may be further provided based on the usage pattern of the one or more other users. An influence score associated with each user for which a usage pattern is determined may be calculated, where the influence score may determine an impact the usage pattern for each user has in determining the recommendation to be provided.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method to provide suggestions for content collaboration, the method comprising:
in response to detecting an opening of a document through an application user experience, monitoring one or more actions performed in conjunction with the document to determine a usage pattern associated with the document;
determining an identifier associated with the document;
determining, other interactions with the document based on the identifier; and
providing a recommendation to be displayed through the application user experience based on the usage pattern associated with the document, the identifier, and the other interactions with the document, wherein the recommendation includes one or more collaboration tools.

2. The method of claim 1, wherein determining other interactions with the document based on the identifier comprises:
determining a usage pattern of one or more other users associated with the document by monitoring one or more actions of the one or more other users performed in conjunction with the document; and
further providing the recommendation based on the usage pattern of the one or more other users.

3. The method of claim 1, further comprising:
calculating an influence score associated with each user for which a usage pattern is determined, wherein the influence score determines an impact the usage pattern for each user has in determining the recommendation to be provided.

4. The method of claim 1, further comprising:
filtering the one or more actions based on a type of action and a length of action.

5. The method of claim 1, wherein providing the recommendation to be displayed through the application user experience comprises:
providing the recommendation for display such that a user is enabled to select one or more of the collaboration tools included in the recommendation through the application user experience to implement the selected collaboration tools.

6. The method of claim 1, wherein providing the recommendation to be displayed through the application user, experience comprises:
configuring the recommendation as a notification; and
providing the notification to be displayed as a window notification, an email notification, or a ribbon notification.

7. The method of claim 1, further comprising:
determining at least one collaboration network based on the usage pattern associated with the document, the identifier, and the other interactions with the document; and
providing an option to select to share the document with the at least one collaboration network within the recommendation.

8. The method of claim 1, wherein the identifier comprises users who have interacted with the document, a frequency at which the users interacted with the document, relationships between the users who have interacted with the document, tags associated with the document, a content type of the document, attributes of the documents, and/or other documents related to the document.

9. The method of claim 1, wherein the usage pattern includes a frequency at which a user interacts with the document, types of actions the user performs on the document, and a frequency at which each of the types of actions is performed on the document by the user.

10. The method of claim 1, wherein the one or more communication tools include communication-based tools, file-sharing tools, co-authoring tools, real-time typing tools, and networking-based tools.

11. A server to provide recommendations for content collaboration, the server comprising:
a memory configured to store instructions; and
one or more processors coupled to the memory, the one or more processors configured to execute, in conjunction with the instructions stored in the memory, a collaboration detection module, wherein the collaboration detection module is configured to:
in response to detection of an opening of a document associated with a productivity service through an application user experience, monitor one or more actions performed in conjunction with the document to determine a usage pattern associated with the document;
determine an identifier associated with the document;
determine other interactions with the document based on the identifier; and
provide a recommendation to be displayed through the application user experience based on the usage pattern associated with the document, the identifier, and the other interactions with the document, wherein the recommendation includes one or more collaboration tools.

12. The server of claim 11, wherein the collaboration detection module is further configured to employ one or more algorithms to determine the recommendation to provide for display based on the usage pattern associated with the document, the identifier, and the other interactions with the document.

13. The server of claim 11, wherein the one or more processors, in conjunction with the instructions stored in the memory, are further configured to execute a notification module to configure the recommendation as a window notification, an email notification, or a ribbon notification to be displayed through the application user experience.

14. The server of claim 11, wherein the collaboration detection module is configured to provide the recommendation to be displayed through the application user experience such that the recommendation is displayed consistently across a plurality of platforms and devices.

15. The server of claim 11, wherein the monitored one or more actions comprise editing, annotating, commenting, sharing, and/or saving of the document.

16. The server of claim 11, wherein the collaboration detection module is an integral module of a productivity service or a third party service.

17. The server of claim 11, wherein the document is one or more of a word-processing document, a presentation document, a spreadsheet document, a communication document, and a notebook document.

18. A computer-readable memory device with instructions stored thereon to provide recommendations for content collaboration, the instructions comprising:
in response to detecting an opening of a document through an application user experience, monitoring one or more actions performed in conjunction with the document to determine a usage pattern associated. with the document;
determining an identifier associated with the document;
determining other interactions with the document based on the identifier; and
providing a recommendation to be displayed through the application user experience based on the usage pattern associated with the document, the identifier, and the other interactions with the document, wherein the recommendation includes one or more collaboration tools and implementation of the one or more collaboration tools, is enabled in response to a selection of the recommendation through the application user experience.

19. The computer-readable memory device of claim 18, wherein the instructions further comprise:
determining a usage pattern of one or more other users associated with the document; and
further providing the recommendation based on the usage pattern of the one or more other users.

20. The computer-readable memory device of claim 18, wherein the instructions further comprise:
calculating an influence score associated with each user for which a usage pattern is determined, wherein the influence score determines an impact the usage pattern for each user has in determining the recommendation to be provided.
